(19) United States
(12) Patent Application Publication
(10) Pub. No.: US 2015/0091755 A1
(43) Pub. Date: Apr. 2, 2015

(54) INTERFERENCE REDUCTION SYSTEM FOR ONE OR MORE ANTENNAS

(71) Applicant: John Mezzalingua Associates, LLC, Liverpool, NY (US)

(72) Inventor: Shawn M. Chawgo, Cicero, NY (US)

(73) Assignee: John Mezzalingua Associates, LLC, Liverpool, NY (US)

(21) Appl. No.: 14/497,575

(22) Filed: Sep. 26, 2014

Related U.S. Application Data
(60) Provisional application No. 61/883,516, filed on Sep. 27, 2013.

(51) Int. Cl. H01Q 3/04

(52) U.S. Cl. CPC H01Q 3/04
USPC 342/359

(57) ABSTRACT

An interference reduction system is operable to reduce interference experienced by one or more antennas. The system detects the presence of one or more interference signals. The system then causes an antenna's radiation pattern to change. The change in the radiation pattern results in a reduction in interference.

### CROSS-REFERENCE TO RELATED APPLICATION

This application is a non-provisional of, and claims the benefit and priority of, U.S. Provisional Patent Application No. 61/883,516, filed on Sep. 27, 2013. The entire contents of such application are hereby incorporated by reference.

### BACKGROUND

Certain antennas send and receive signals that enable mobile phone users to wirelessly communicate. Some of these antennas are mounted on high, outdoor towers. Others are mounted on rooftops and inside large buildings, such as sports stadiums.

There are a number of factors that can cause interference with these antennas. The antennas can interfere with each other. For example, one antenna's radiation beam can interfere with another antenna's radiation beam. In addition, objects can act as reflectors. The reflectors can receive radiation beams from one or more antennas and then reflect radiation toward an antenna. The reflected radiation can cause interference.

When an antenna experiences interference, the antenna's performance can be degraded. For example, the strength of the radiated signal can be significantly decreased. A low strength signal can cause poor connections and dropped calls for mobile phone users.

Businesses, such as stadium owners, often do not know exactly when phone users are experiencing problems due to antenna interference. Consequently, stadium attendees can be dissatisfied with their mobile phone service for extended periods of time. When the business finally identifies the interference problem for a particular antenna, the business must undertake labor-intensive steps to address the problem. For example, the business' technician must use a ladder or boom machine to reach an antenna. Then, the technician must un-bracket and demount the antenna and then experiment with different orientations to find a lower interference level. When the technician finds a suitable orientation, he/she must then mount the antenna at such orientation. Finally, the technician must use the ladder or boom to return to floor level. This process can be highly labor intensive and highly time consuming especially for large venues with over one hundred antennas, for example.

Many facilities are upgraded or remodeled from time to time. For example, a stadium owner might install new sky box rooms or add an overhead bridge for camera crew. When these changes occur, one or more of the antennas might experience interference again. The technician must then repeat the labor intensive, reorientation process for those antennas.

Therefore, there is a need to overcome, or otherwise lessen the effects of, the disadvantages and shortcomings described above.

### SUMMARY

In one embodiment, the interference reduction system is operable in conjunction with one or more antennas. The interference reduction system includes at least one antenna control module configured to be operatively coupled to at least one of the antennas. The at least one antenna is operable to produce radiation having a radiation pattern. The radiation pattern has at least one null. The at least one antenna control module is configured to: (a) start a detection mode when a detection start condition is satisfied independent of any input from a user; (b) control an antenna motor that is operatively coupled to the at least one antenna so as to cause the at least one antenna to rotate during the detection mode; (c) detect at least one source of interference within a detectable range of the at least one antenna, wherein the at least one antenna receives one or more interference signals caused by the at least one source of interference; and (d) control the at least one antenna motor to stop the rotation of the at least one antenna so as to align the at least one null with a direction of the received one or more interference signals.

In one or more embodiments: (a) the at least one antenna control module is at least partially incorporated into a distributed antenna manager that manages the at least one antenna and a plurality of other antennas; (b) the at least one antenna control module is at least partially incorporated into a remote radio unit that is operatively coupled to the at least one antenna; (c) the at least one antenna control module comprises a data storage device; (d) the data storage device stores a plurality of machine-readable instructions that are executable by a processor; and (e) the at least one antenna control module comprises at least one circuit.

In one embodiment, the detection start condition comprises one of: (a) a detection time schedule; (b) an expiration of a period of time; and (c) a sensor signal generated by a sensor, wherein the sensor is operatively coupled to the at least one antenna control module.

The radiation pattern, in one embodiment, has a plurality of lobes and first and second nulls and wherein the at least one antenna control module is configured to: (a) detect a first interference signal that traveled in a first direction toward the at least one antenna and was received by the at least one antenna during the detection mode; (b) detect a second interference signal that traveled in a second direction toward the at least one antenna and was received by the at least one antenna during the detection mode; and (c) control the at least one antenna motor to stop the rotation of the at least one antenna so as to: (i) reposition the first null to be closer to the first direction of the first interference signal; and (ii) reposition the second null to be closer to the second direction of the second interference signal.

In another embodiment, the interference reduction system comprises at least one antenna control module configured to be operatively coupled to the at least one antenna. The at least one antenna is operable to produce radiation having a radiation pattern. The radiation pattern has at least one null. The at least one antenna control module is configured to cause the at least one null to be aligned with one or more interference signals traveling toward the at least one antenna.

In one embodiment, the at least one antenna control module is configured to receive a sensor input from a sensor that is operatively coupled to the at least one antenna control module. The at least one antenna control module is configured to cause the at least one null to be aligned with the interference signal in response to the sensor signal.

In another embodiment, the at least one antenna control module is configured to produce one or more detection signals associated with the interference signal. The at least one antenna control module is configured to cause the at least one null to be aligned with the interference signal in response to the one or more detection signals.

In one or more embodiments: (a) the at least one antenna control module is at least partially incorporated into a distributed antenna manager that manages the at least one antenna and a plurality of other antennas; (b) the at least one antenna control module is at least partially incorporated into a remote radio unit that is operatively coupled to the at least one antenna; (c) the at least one antenna control module comprises a plurality of machine-readable instructions that are executable by a processor; (d) the at least one antenna control module comprises at least one circuit; (e) the at least one antenna control module comprises a motor control module configured to control an antenna motor that is operatively coupled to the at least one antenna; and (f) the at least one antenna control module comprises a phase shift module configured to change the radiation pattern without physically moving the at least one antenna.

The interference reduction system, in one embodiment, has at least one antennal control module configured to be operatively coupled to the at least one antenna. The at least one antenna is operable to produce radiation including a plurality of antenna signals. The radiation has a radiation pattern. The radiation pattern has at least one lobe. The radiation pattern also has at least one non-lobe area where a plurality of the antenna signals at least partially cancel each other.

The at least one antenna control module is configured to: (a) monitor at least one antenna for at least one undesirable signal traveling in a direction toward the at least one antenna, wherein the at least one undesirable signal causes a level of interference with at least one of the antenna signals; (b) produce at least one detection signal after the at least one undesirable signal is detected; and (c) in response to the at least one detection signal, align the at least one non-lobe area with the direction of the detected undesirable signal to reduce the level of interference.

In one embodiment, the at least one antennal control module is operatively coupled to an antenna motor that is operatively coupled to an antenna mover. The at least one antenna mover is configured to move the at least one antenna. The at least one antennal control module is configured to cause the at least one antenna mover to incrementally move the at least one antenna during the monitoring.

In another embodiment, the at least one antennal control module is configured to cause the at least one antenna mover to move the at least one antenna until the at least one non-lobe area is aligned with the direction of the detected undesirable signal.

Additional features and advantages of the present disclosure are described in, and will be apparent from, the following Brief Description of the Drawings and Detailed Description.

### BRIEF DESCRIPTION OF THE DRAWINGS

Additional features and advantages of the present disclosure are described in, and will be apparent from, the following Brief Description of the Drawings and Detailed Description.

FIG. 1 is a schematic diagram illustrating an example of one embodiment of an outdoor wireless communication network.

FIG. 2 is a schematic diagram illustrating an example of one embodiment of an indoor wireless communication network.

FIG. 3 is an isometric view of one embodiment of a base station illustrating a tower and ground shelter.

FIG. 4 is an isometric view of one embodiment of a tower.

FIG. 5 is an isometric view of one embodiment of an interface port.

FIG. 6 is an isometric view of another embodiment of an interface port.

FIG. 7 is an isometric view of yet another embodiment of an interface port.

FIG. 8 is an isometric, cut-away view of one embodiment of a cable connector and cable.

FIG. 9 is an isometric, exploded view of one embodiment of a cable assembly having a cover.

FIG. 10 is an isometric view of one embodiment of a cable connector covered by a cover.

FIG. 11 is a schematic diagram of one embodiment of an environment having one embodiment of the interference reduction system.

FIG. 12 is a schematic diagram of another embodiment of an environment having another embodiment of the interference reduction system.

FIG. 13 is a schematic diagram of one embodiment of the interference reduction system and a plurality of embodiments of the antenna control module.

FIG. 14 is a schematic diagram of one embodiment of a DAS antenna unit, one embodiment of a remote radio head or unit and one embodiment of a DAS manager.

FIG. 15 is a one example of a polar plot of an example of a radiation pattern of an antenna.

FIG. 16 is a one example of a polar plot of an example of a radiation pattern of a DAS antenna unit, illustrating the interference reduction system's effect of aligning a null with directions or lines of interference from multiple interference sources.

FIG. 17 is a graph illustrating an example of the decrease in interference achieved by one embodiment of the interference reduction system.

### DETAILED DESCRIPTION

### 1. Overview

1.1 Wireless Communication Networks

In one embodiment, wireless communications are operable based on a network switching subsystem (“NSS”). The NSS includes a circuit-switched core network for circuit-switched phone connections. The NSS also includes a general packet radio service architecture which enables mobile networks, such as 2G, 3G and 4G mobile networks, to transmit Internet Protocol (“IP”) packets to external networks such as the Internet. The general packet radio service architecture enables mobile phones to have access to services such as Wireless Application Protocol (“WAP”), Multimedia Messaging Service (“MSS”) and the Internet.

A service provider or carrier operates a plurality of centralized mobile telephone switching offices (“MTSOs”). Each MTSO controls the base stations within a select region or cell surrounding the MTSO. The MTSOs also handle connections to the Internet and phone connections.

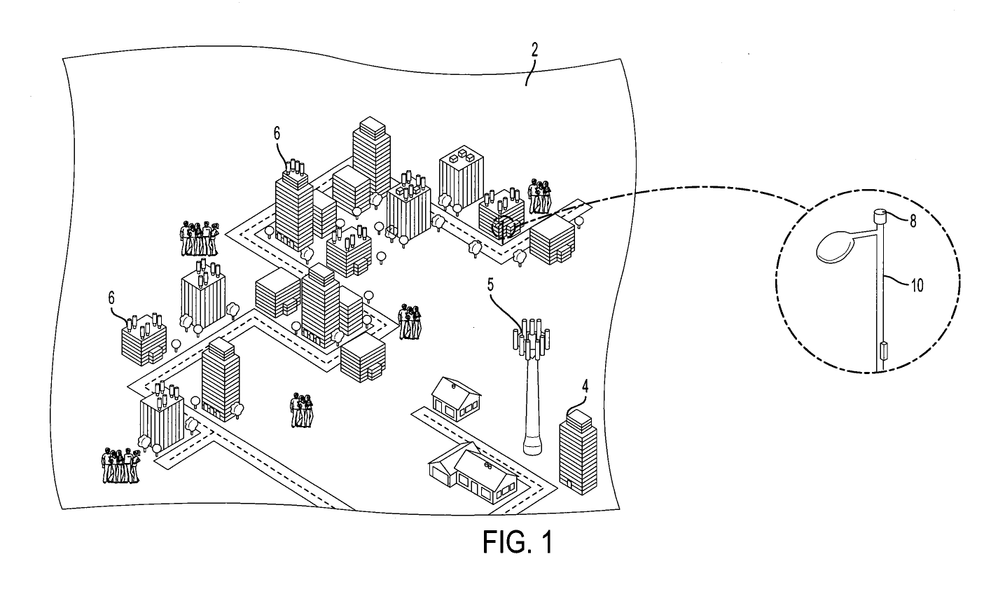

Referring to FIG. 1, an outdoor wireless communication network 2 includes a cell site or cellular base station 4. The base station 4, in conjunction with cellular tower 5, serves communication devices, such as mobile phones, in a defined area surrounding the base station 4. The cellular tower 5 also communicates with macro antennas 6 on building tops as well as micro antennas 8 mounted to, for example, street lamps 10.

The cell size depends upon the type of wireless network. For example, a macro cell can have a base station antenna installed on a tower or a building above the average rooftop level, such as the macro antennas 5 and 6. A micro cell can have an antenna installed at a height below the average rooftop level, often suitable for urban environments, such as the street lamp-mounted micro antenna 8. A pico cell is a relatively small cell often suitable for indoor use.

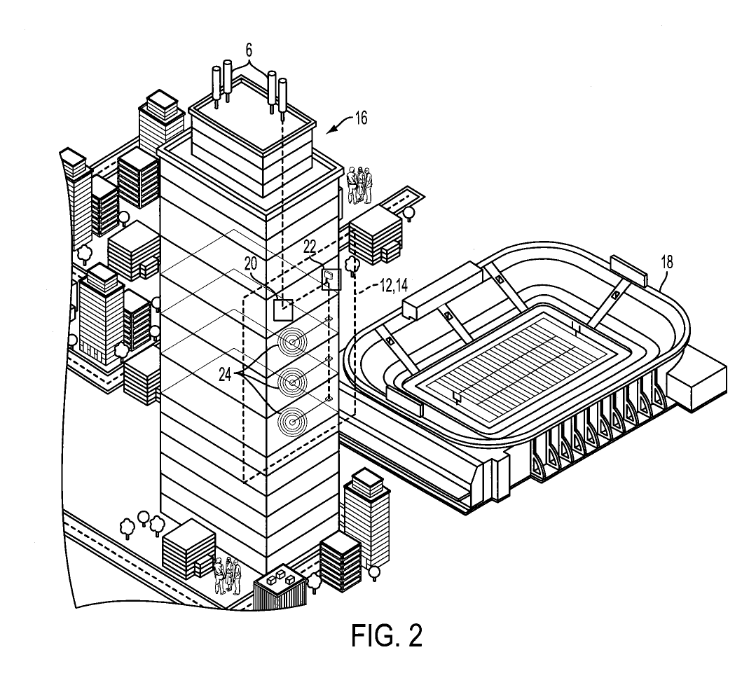

As illustrated in FIG. 2, an indoor wireless communication network 12 includes an active distributed antenna system (“DAS”) 14. The DAS 14 can, for example, be installed in a high rise commercial office building 16, a sports stadium 18 or a shopping mall. In one embodiment, the DAS 14 includes macro antennas 6 coupled to a radio frequency (“RF”) repeater 20. The macro antennas 6 receive signals from a nearby base station. The RF repeater 20 amplifies and repeats the received signals. The RF repeater 20 is coupled to a DAS master unit or DAS manager 22 which, in turn, is coupled to a plurality of remote antenna units 24 distributed throughout the building 16. Depending upon the embodiment, the DAS manager 22 can control and manage over one hundred remote antenna units 24 in a building 16. In one embodiment, the DAS manager 22 includes a server having one or more databases and data processors. In operation, the DAS manager 22 is programmed to control and manage the coverage and performance of the remote antenna units 24 based on the number of repeated signals fed by the repeater 20. It should be appreciated that a technician can remotely adjust and control the DAS manager 22 through a Local Area Network (LAN) connection or wireless modem.

Depending upon the embodiment, the RF repeater 20 can be an analog repeater that amplifies all received signals, or the RF repeater 20 can be a digital repeater. In one embodiment, the digital repeater includes a processor and a memory device or data storage device. The data storage device stores logic in the form of computer-readable instructions. The processor executes the logic to filter or clean the received signals before repeating the signals. In one embodiment, the digital repeater does not need to receive signals from an external antenna, but rather, has a built-in antenna located within its housing.

1.2 Base Stations

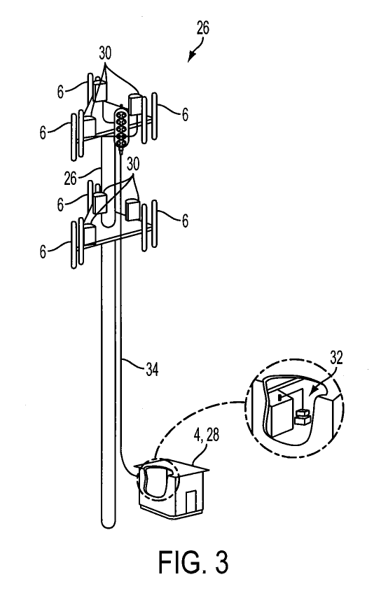

In one embodiment illustrated in FIG. 3, the base station 4 includes a tower 26 and a ground shelter 28 next to the tower 26. In this example, a plurality of exterior antennas 6 and remote radio heads 30 are mounted to the tower 26. The shelter 28 encloses base station equipment 32. Depending upon the embodiment, the base station equipment 32 includes electrical hardware operable to transmit and receive radio signals and to encrypt and decrypt communications with the MTSO. The base station equipment 32 also includes power supply units and equipment for powering and controlling the antennas and other devices mounted to the tower 26.

In one embodiment, a distribution line 34, such as coaxial cable or fiber optic cable, distributes signals that are exchanged between the base station equipment 32 and the remote radio heads 30. Each remote radio head 30 is operatively coupled to, and mounted adjacent to, a group of associated macro antennas 6. Each remote radio head 30 manages the distribution of signals between its associated macro antennas 6 and the base station equipment 30. In one embodiment, the remote radio heads 30 extend the coverage and efficiency of the macro antennas 6. Each remote radio head 30, in one embodiment, has RF circuitry, analog-to-digital/digital-to-analog converters and up/down converters, including a transceiver.

1.3 Antennas

The antennas, such as macro antennas 6, micro antennas 8 and remote antenna units 24, are operable to receive signals from communication devices and send signals to the communication devices. Depending upon the embodiment, the antennas can be of different types, including, but not limited to, directional antennas, omni-directional antennas, isotropic antennas, dish-shaped antennas, and microwave antennas. Directional antennas can improve reception in higher traffic areas, along highways, and inside buildings like stadiums and arenas. Based upon applicable laws and legal regulations, a service provider may operate omni-directional cell tower signals up to a maximum power, such as 100 watts, while the service provider may operate directional cell tower signals up to a higher maximum of effective radiated power (“ERP”), such as 500 watts.

An omni-directional antenna is operable to radiate radio wave power uniformly, or substantially uniformly, in all directions in one plane. The radiation pattern can be similar to a doughnut shape where the antenna is at the center of the doughnut. The radial distance from the center represents the power radiated in that direction. The power radiated is maximum in horizontal directions, dropping to zero directly above and below the antenna.

An isotropic antenna is operable to radiate equal, or substantially equal, power in all directions and has a spherical radiation pattern. Omni-directional antennas, when properly mounted, can save energy in comparison to isotropic antennas. For example, since their radiation drops off with elevation angle, little radio energy is aimed into the sky or down toward the earth where it could be wasted. In contrast to omni-directional antennas, isotropic antennas can waste such upwardly and downwardly aimed energy.

In one embodiment, the antenna has: (a) an antenna support or frame; (b) a conductor, dipole, radiator or radiator array supported by the antenna frame; (c) a transmitting data port, a receiving data port, or a transceiver data port; (d) a motor; (e) a housing or enclosure that covers the motor and the radiator array; and (f) a drive assembly or drive mechanism that couples the motor to the antenna frame. Depending upon the embodiment, the radiator array can be tiltably, pivotably or rotatably mounted to the antenna frame.

One or more cables connect the antenna to one of the remote radio heads 30, which provides electrical power and motor control signals to the antenna. A technician of a service provider can reposition the antenna by providing desired inputs using the base station equipment 32. For example, if the antenna has poor reception, the technician can enter tilt inputs to change the azimuth or elevation angle of the antenna from the ground without having to climb up to reach the antenna. In one embodiment, the antenna's motor drives the antenna frame to the specified position. In another embodiment, the antenna's motor controls a phase shifter of the antenna, and the phase shifter changes the antenna's beam or radiation pattern to tilt in a different direction. In such embodiment, the antenna does not physically tilt or move, but rather, the radiation pattern is generated in a tilted direction. Depending upon the embodiment, a technician can control the position or orientation of the antenna from the base station, from a distant office or from a land vehicle by providing inputs over the Internet.

1.4 Data Interface Ports

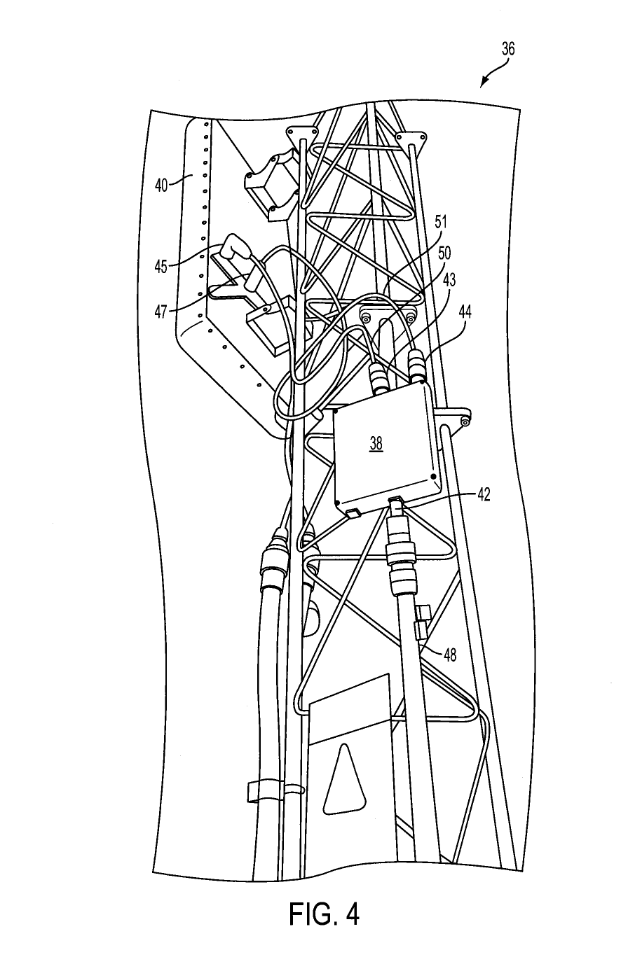

Generally, the networks 2 and 12 include a plurality of wireless network devices, including, but not limited to, the base station equipment 32, one or more radio heads 30, macro antennas 6, micro antennas 8, RF repeaters 20 and remote antenna units 24. As described above, these network devices include data interface ports that couple to connectors of signal-carrying cables, such as coaxial cables and fiber optic cables. In the example illustrated in FIG. 4, the tower 36 supports a radio head 38 and macro antenna 40. The radio head 38 has interface ports 42, 43 and 44 and the macro antenna 40 has antenna ports 45 and 47. In the example shown, the coaxial cable 48 is connected to the radio head interface port 42, while the coaxial cable jumpers 50 and 51 are connected to radio head interface ports 43 and 44, respectively. The coaxial cable jumpers 50 and 51 are also connected to antenna interface ports 45 and 47, respectively.

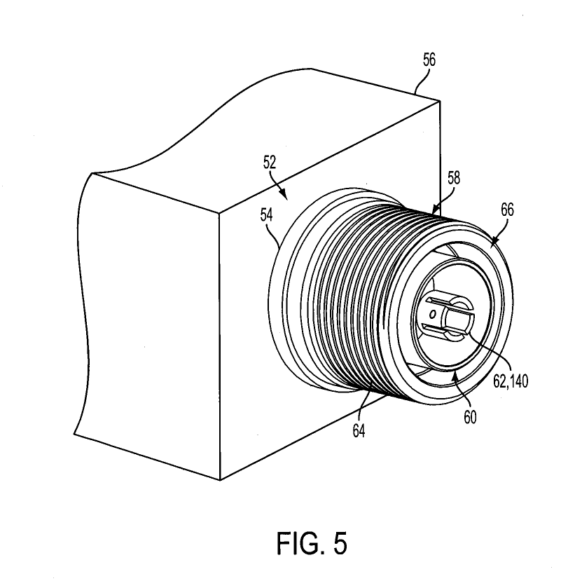

The interface ports of the networks 2 and 12 can have different shapes, sizes and surface types depending upon the embodiment. In one embodiment illustrated in FIG. 5, the interface port 52 has a tubular or cylindrical shape. The interface port 52 includes: (a) a forward end or base 54 configured to abut the network device enclosure, housing or wall 56 of a network device; (b) a coupler engager 58 configured to be engaged with a cable connector's coupler, such as a nut; (c) an electrical ground 60 received by the coupler engager 58; and (d) a signal carrier 62 received by the electrical grounder 60.

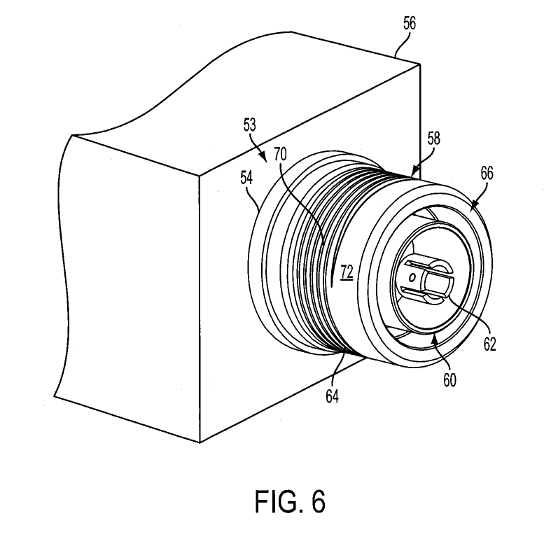

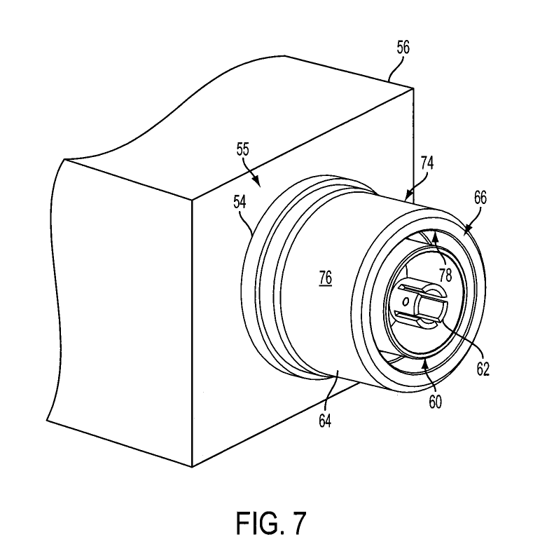

In the illustrated embodiment, the base 54 has a collar shape with a diameter larger than the diameter of the coupler engager 58. The coupler engager 58 is tubular in shape, has a threaded, outer surface 64 and a rearward end 66. The threaded outer surface 64 is configured to threadably mate with the threads of the coupler of a cable connector, such as connector 68 described below. In one embodiment illustrated in FIG. 6, the interface port 53 has a forward section 70 and a rearward section 72 of the coupler engager 62. The forward section 70 is threaded, and the rearward section 72 is non-threaded. In another embodiment illustrated in FIG. 7, the interface port 55 has a coupler engager 74. In this embodiment, the coupler engager 74 is the same as coupler engager 58 except that it has a non-threaded, outer surface 76 and a threaded, inner surface 78. The threaded, inner surface 78 is configured to be inserted over, and threadably engaged with, a cable connector.

Referring to FIGS. 5-8, in one embodiment, the signal carrier 62 is tubular and configured to receive a pin or inner conductor engager 80 of the cable connector 68. Depending upon the embodiment, the signal carrier 62 can have a plurality of fingers 82 which are spaced apart from each other about the perimeter of the signal carrier 80. When the cable inner conductor 84 is inserted into the signal carrier 80, the fingers 82 apply a radial, inward force to the inner conductor 84 to establish a physical and electrical connection with the inner conductor 84. The electrical connection enables data signals to be exchanged between the devices that are in communication with the interface port. In one embodiment, the electrical ground 60 is tubular and configured to mate with a connector ground 86 of the cable connector 68. The connector ground 86 extends an electrical ground path to the ground 64 as described below.

1.5 Cables

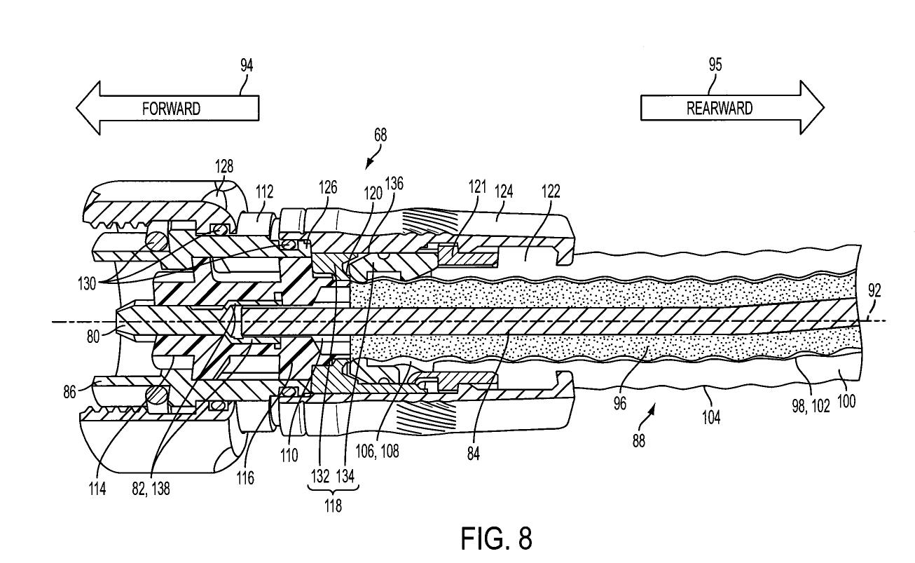

In one embodiment illustrated in FIGS. 4 and 8-10, the networks 2 and 12 include one or more types of coaxial cables 88. In the embodiment illustrated in FIG. 8, the coaxial cable 88 has: (a) a conductive, central wire, tube, strand or inner conductor 84 that extends along a longitudinal axis 92 in a forward direction 94 toward the interface port 56; (b) a cylindrical or tubular dielectric, or insulator 96 that receives and surrounds the inner conductor 84; (c) a conductive tube or outer conductor 98 that receives and surrounds the insulator 96; and (d) a sheath, sleeve or jacket 100 that receives and surrounds the outer conductor 98. In the illustrated embodiment, the outer conductor 98 is corrugated, having a spiral, exterior surface 102. The exterior surface 102 defines a plurality of peaks and valleys to facilitate flexing or bending of the cable 88 relative to the longitudinal axis 92.

To achieve the cable configuration shown in FIG. 8, an assembler/preparer, in one embodiment, takes one or more steps to prepare the cable 90 for attachment to the cable connector 68. In one example, the steps include: (a) removing a longitudinal section of the jacket 104 to expose the bare surface 106 of the outer conductor 108; (b) removing a longitudinal section of the outer conductor 108 and insulator 96 so that a protruding end 110 of the inner conductor 84 extends forward, beyond the recessed outer conductor 108 and the insulator 96, forming a step-shape at the end of the cable 68; and (c) removing or coring-out a section of the recessed insulator 96 so that the forward-most end of the outer conductor 106 protrudes forward of the insulator 96.

In another embodiment not shown, the cables of the networks 2 and 12 include one or more types of fiber optic cables. Each fiber optic cable includes a group of elongated light signal guides or flexible tubes. Each tube is configured to distribute a light-based or optical data signal to the networks 2 and 12.

1.6 Connectors

In the embodiment illustrated in FIG. 8, the cable connector 68 includes: (a) a connector housing or connector body 112; (b) a connector insulator 114 received by, and housed within, the connector body 112; (c) the inner conductor engager 80 received by, and slidably positioned within, the connector insulator 114; (d) a driver 116 configured to axially drive the inner conductor engager 80 into the connector insulator 114 as described below; (e) an outer conductor clamp device or outer conductor clamp assembly 118 configured to clamp, sandwich, and lock onto the end section 120 of the outer conductor 106; (f) a clamp driver 121; (g) a tubular-shaped, deformable, environmental seal 122 that receives the jacket 104; (h) a compressor 124 that receives the seal 122, clamp driver 121, clamp assembly 118, and the rearward end 126 of the connector body 112; (i) a nut, fastener or coupler 128 that receives, and rotates relative to, the connector body 112; and (j) a plurality of O-rings or ring-shaped environmental seals 130. The environmental seals 122 and 130 are configured to deform under pressure so as to fill cavities to block the ingress of environmental elements, such as rain, snow, ice, salt, dust, debris and air pressure, into the connector 68.

In one embodiment, the clamp assembly 118 includes: (a) a supportive outer conductor engager 132 configured to be inserted into part of the outer conductor 106; and (b) a compressive outer conductor engager 134 configured to mate with the supportive outer conductor engager 132. During attachment of the connector 68 to the cable 88, the cable 88 is inserted into the central cavity of the connector 68. Next, a technician uses a hand-operated tool or electrical power tool to axially push the compressor 124 in the forward direction 94 while holding the connector body 112 in place. For the purposes of establishing a frame of reference, the forward direction 94 is toward interface port 55, and the rearward direction 95 is away from the interface port 55.

The compressor 124 has an inner, tapered surface 136 defining a ramp and interlocks with the clamp driver 121. As the compressor 124 moves forward, the clamp driver 121 is urged forward which, in turn, pushes the compressive outer conductor engager 134 toward the supportive outer conductor engager 132. The engagers 132 and 134 sandwich the outer conductor end 120 positioned between the engagers 132 and 134. Also, as the compressor 124 moves forward, the tapered surface or ramp 136 applies an inward, radial force that compresses the engagers 132 and 134, establishing a lock onto the outer conductor end 120. Furthermore, the compressor 124 urges the driver 121 forward which, in turn, pushes the inner conductor engager 80 into the connector insulator 114.

The connector insulator 114 has an inner, tapered surface with a diameter less than the outer diameter of the mouth or grasp 138 of the inner conductor engager 80. When the driver 116 pushes the grasp 138 into the insulator 114, the diameter of the grasp 138 is decreased to apply a radial, inward force on the inner conductor 84 of the cable 88. As a consequence, a bite or lock is produced on the inner conductor 84.

After the cable connector 68 is attached to the cable 88, a technician or user can install the connector 68 onto an interface port, such as the interface port 52 illustrated in FIG. 5. In one example, the user screws the coupler 128 onto the port 52 until the fingers 140 of the signal carrier 62 receive, and make physical contact with, the inner conductor engager 80 and until the ground 60 engages, and makes physical contact with, the outer conductor engager 86. During operation, the non-conductive, connector insulator 114 and the non-conductive driver 116 serve as electrical barriers between the inner conductor engager 80 and the one or more electrical ground paths surrounding the inner conductor engager 80. As a result, the likelihood of an electrical short is mitigated, reduced or eliminated. One electrical ground path extends: (a) from the outer conductor 106 to the clamp assembly 118, (b) from the conductive clamp assembly 118 to the conductive connector body 112, and (c) from the conductive connector body 112 to the conductive ground 60. An additional or alternative electrical grounding path extends: (a) from the outer conductor 106 to the clamp assembly 118, (b) from the conductive clamp assembly 118 to the conductive connector body 112, (c) from the conductive connector body 112 to the conductive coupler 128, and (d) from the conductive coupler 128 to the conductive ground 60.

These one or more grounding paths provide an outlet for electrical current resulting from magnetic radiation in the vicinity of the cable connector 88. For example, electrical equipment operating near the connector 68 can have electrical current resulting in magnetic fields, and the magnetic fields could interfere with the data signals flowing through the inner conductor 84. The grounded outer conductor 106 shields the inner conductor 84 from such potentially interfering magnetic fields. Also, the electrical current flowing through the inner conductor 84 can produce a magnetic field that can interfere with the proper function of electrical equipment near the cable 88. The grounded outer conductor 106 also shields such equipment from such potentially interfering magnetic fields.

The internal components of the connector 68 are compressed and interlocked in fixed positions under relatively high force. These interlocked, fixed positions reduce the likelihood of loose internal parts that can cause undesirable levels of passive intermodulation (“PIM”) which, in turn, can impair the performance of electronic devices operating on the networks 2 and 12. PIM can occur when signals at two or more frequencies mix with each other in a non-linear manner to produce spurious signals. The spurious signals can interfere with, or otherwise disrupt, the proper operation of the electronic devices operating on the networks 2 and 12. Also, PIM can cause interfering RF signals that can disrupt communication between the electronic devices operating on the networks 2 and 12.

In one embodiment where the cables of the networks 2 and 12 include fiber optic cables, such cables include fiber optic cable connectors. The fiber optic cable connectors operatively couple the optic tubes to each other. This enables the distribution of optical or light-based signals between different cables and between different network devices.

1.7 Supplemental Grounding

In one embodiment, grounding devices are mounted to towers such as the tower 36 illustrated in FIG. 4. For example, a grounding kit or grounding device can include a grounding wire and a cable fastener which fastens the grounding wire to the outer conductor 106 of the cable 88. The grounding device can also include: (a) a ground fastener which fastens the ground wire to a grounded part of the tower 36; and (b) a mount which, for example, mounts the grounding device to the tower 23. In operation, the grounding device provides an additional ground path for supplemental grounding of the cables 88.

1.8 Environmental Protection

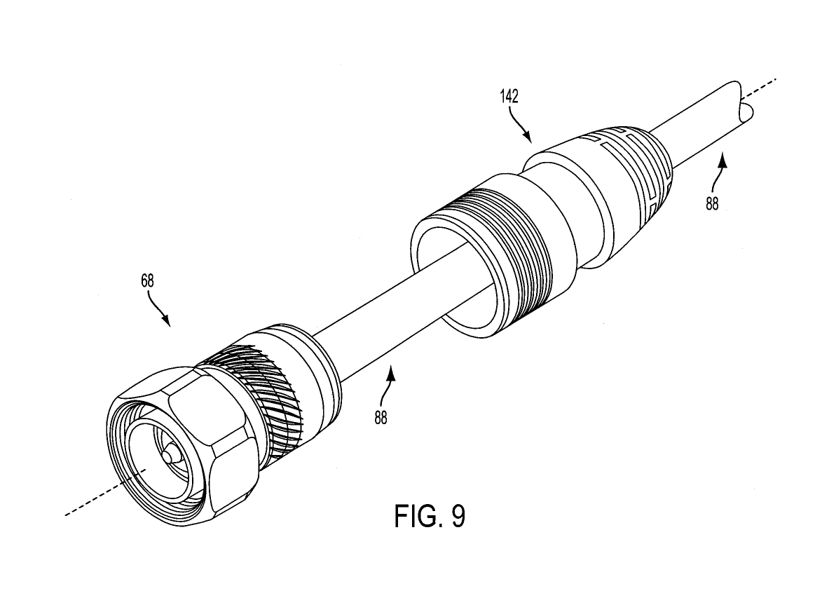

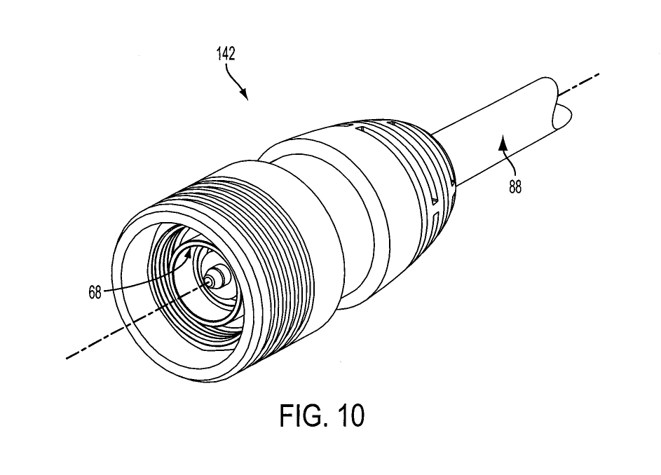

In one embodiment, a protective boot or cover, such as the cover 142 illustrated in FIGS. 9-10, is configured to enclose part or all of the cable connector 88. In another embodiment, the cover 142 extends axially to cover the connector 68, the physical interface between the connector 68 and the interface port 52, and part or all of the interface port 52. The cover 142 provides an environmental seal to prevent the infiltration of environmental elements, such as rain, snow, ice, salt, dust, debris and air pressure, into the connector 68 and the interface port 52. Depending upon the embodiment, the cover 142 may have a suitable foldable, stretchable or flexible construction or characteristic. In one embodiment, the cover 142 may have a plurality of different inner diameters. Each diameter corresponds to a different diameter of the cable 88 or connector 68. As such, the inner surface of cover 142 conforms to, and physically engages, the outer surfaces of the cable 88 and the connector 68 to establish a tight environmental seal. The air-tight seal reduces cavities for the entry or accumulation of air, gas and environmental elements.

1.9 Materials

In one embodiment, the cable 88, connector 68 and interface ports 52, 53 and 55 have conductive components, such as the inner conductor 84, inner conductor engager 80, outer conductor 106, clamp assembly 118, connector body 112, coupler 128, ground 60 and the signal carrier 62. Such components are constructed of a conductive material suitable for electrical conductivity and, in the case of inner conductor 84 and inner conductor engager 80, data signal transmission. Depending upon the embodiment, such components can be constructed of a suitable metal or metal alloy including copper, but not limited to, copper-clad aluminum (“CCA”), copper-clad steel (“CCS”) or silver-coated copper-clad steel (“SCCCS”).

The flexible, compliant and deformable components, such as the jacket 104, environmental seals 122 and 130, and the cover 142 are, in one embodiment, constructed of a suitable, flexible material such as polyvinyl chloride (PVC), synthetic rubber, natural rubber or a silicon-based material. In one embodiment, the jacket 104 and cover 142 have a lead-free formulation including black-colored PVC and a sunlight resistant additive or sunlight resistant chemical structure. In one embodiment, the jacket 104 and cover 142 weatherize the cable 88 and connection interfaces by providing additional weather protective and durability enhancement characteristics. These characteristics enable the weatherized cable 88 to withstand degradation factors caused by outdoor exposure to weather.

### 2. Interference Reduction System

Referring to FIGS. 1, 2 and 11-12, in one embodiment, the interference reduction system 200 is implemented in a building 16, facility, park, stadium 8, venue or other open or closed environment 202. The cellular tower 5 is operable to generate micro cell or pico cell coverage for the environment 202 as described below. There are one or more DAS remote antenna units 24 mounted or installed on top of or inside the environment 202. The DAS manager 22 manages and controls the DAS antenna units 24 as described above.

Depending upon the embodiment, the DAS manager 22 receives signals from the repeater 20, or the DAS manager 22 receives signals directly from the nearby base station 204. In one embodiment, the DAS manager 22 is operatively coupled to the base station 204 through a coaxial cable. In another embodiment, the DAS manager 22 is operatively coupled to a plurality of base stations 204 through a plurality of coaxial cables.

The environment 202 has a plurality of interference sources 206. The interference sources 206 can include any object, located in or near the environment 202, that is positioned to receive electromagnetic radiation from any DAS remote antenna unit 24 and reflect part or all of the radiation back toward a DAS remote antenna unit 24. Depending upon the design or setup of the environment 202, the interference sources 206 can include building fixtures, building hardware, building structures and parts (such as sheet metal heat ducts, metal vents, metal flashing and metal ceiling tile frames), street lamps, electrical power lines, aircraft and other moving and nonmoving items in or near the environment 202.

In addition, the interference sources 206 can include any electromagnetic radiation generator in or near the environment 202, including, but not limited to, micro antennas near the environment 202, macro antennas near the environment 202, electrical wires and equipment in the environment 202, electrical devices in the environment 202 and rooftop or macro antennas of buildings near the environment 202.

It should be appreciated that the interference sources 206 in a building, for example, can change over time. For example, when the building is first built, the metal heat ducts may be installed in one location where they do not cause reflective interference with the DAS antenna units 24. In two years, however, the building might be upgraded, and new heat ducts could be installed in a different location where they cause reflective interference with one or more DAS antenna units 24.

The interference sources 206 can cause interference with the antenna signals of the DAS antenna units 24 in a number of ways. The interferences sources 204 can significantly reduce the power of the antenna signals of DAS antenna units 24, or the interferences sources 206 can cancel all, or substantially all, of an antenna signal of a DAS antenna unit 24. In addition, the interference sources 206 can cause PIM to be present in the DAS antenna units 24, in the signal-carrying cables and in the indoor wireless communication network 12. Consequently, the PIM and interference sources 206 can cause degradation, interruption or loss of cellular service for subscribers in or near the environment 202.

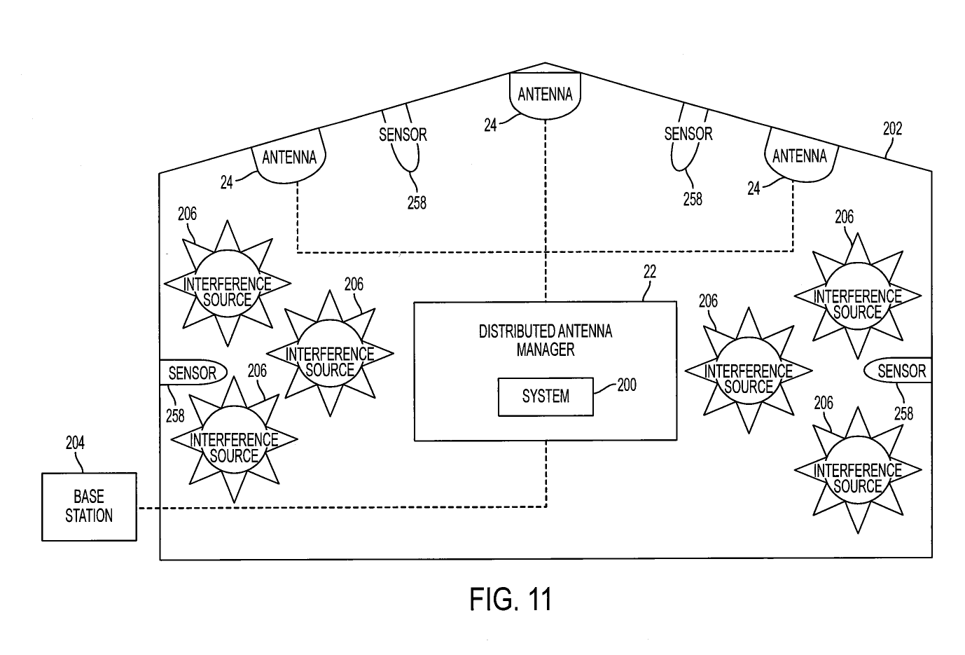

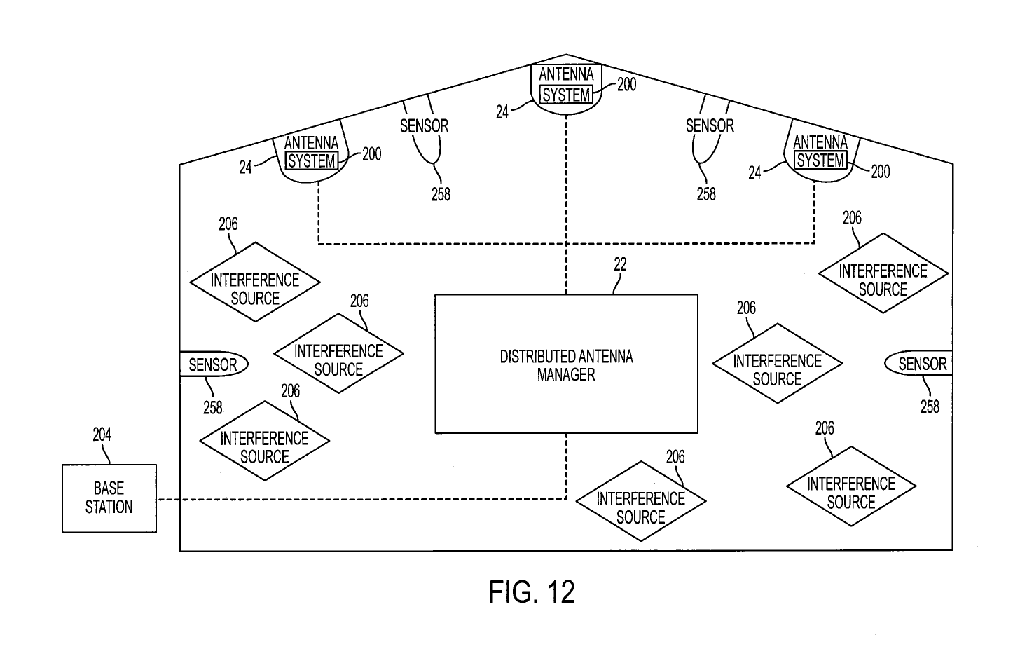

The interference reduction system 200 is operable to reduce the problems cause by such interference. In the embodiment illustrated in FIG. 11, the system 200 is fully or partially incorporated into the DAS manager 22. In the embodiment illustrated in FIG. 12, the system 200 is replicated, and each replica of the system 200 is fully or partially incorporated into one of the DAS remote antenna units 24 or the associated remote radio unit or head 270 described below.

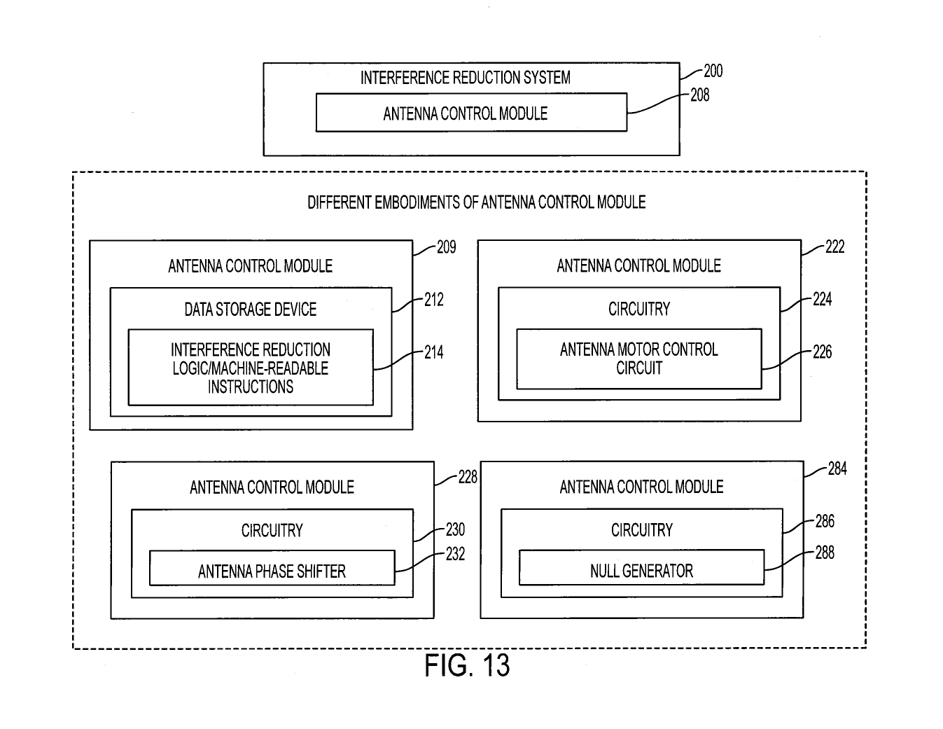

Referring to FIG. 13, the interference reduction system 200, in one embodiment, includes an antenna control module 208. The antenna control module 208 is operable to control certain functionality of one or more of the DAS remote antenna units 24.

In one embodiment, the antenna control module 209 includes a memory device or data storage device 212. The data storage device 212 stores interference reduction logic 214 in the form of computer code, software, algorithms, data libraries or a plurality of machine-readable instructions. The logic 214 is executable by an integrated circuit or data processor of the DAS manager 22. In one embodiment, the data storage device 212 stores uplink spectral monitoring modules. The spectral monitoring modules are configured to enable spectral monitoring of the environment 202 or applicable antenna unit 24 for interference signals. Depending upon the embodiment, the DAS antennas units 24 can be configured to perform such spectral monitoring, as described below, or the sensors 258 can perform such spectral monitoring.

In one embodiment, the memory devices and data storage devices of the antenna control modules 208 and 209 and the DAS manager 22 are tangible, non-transitory computer-readable storage mediums. Such a storage medium may take many forms, including, but not limited to, non-volatile media and volatile media. Non-volatile media include, for example, optical or magnetic disks, flash drives, or any of the storage devices operating within a computer or server. Common forms of non-transitory computer-readable media therefore include, for example: a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, or any other medium from which a computer can read programming code and/or data. Many of these forms of computer readable media may be involved in carrying one or more sequences of one or more instructions to a processor for execution. Volatile media include dynamic memory, such as main memory of such a computer or server.

In contrast to non-transitory mediums, transitory physical transmission media include coaxial cables, copper wire and fiber optics, including the wires that comprise a bus within a computer system, a carrier wave transporting data or instructions, and cables or links transporting such a carrier wave. Carrier-wave transmission media can take the form of electric or electromagnetic signals, or acoustic or light waves such as those generated during radio frequency (RF) and infrared (IR) data communications.

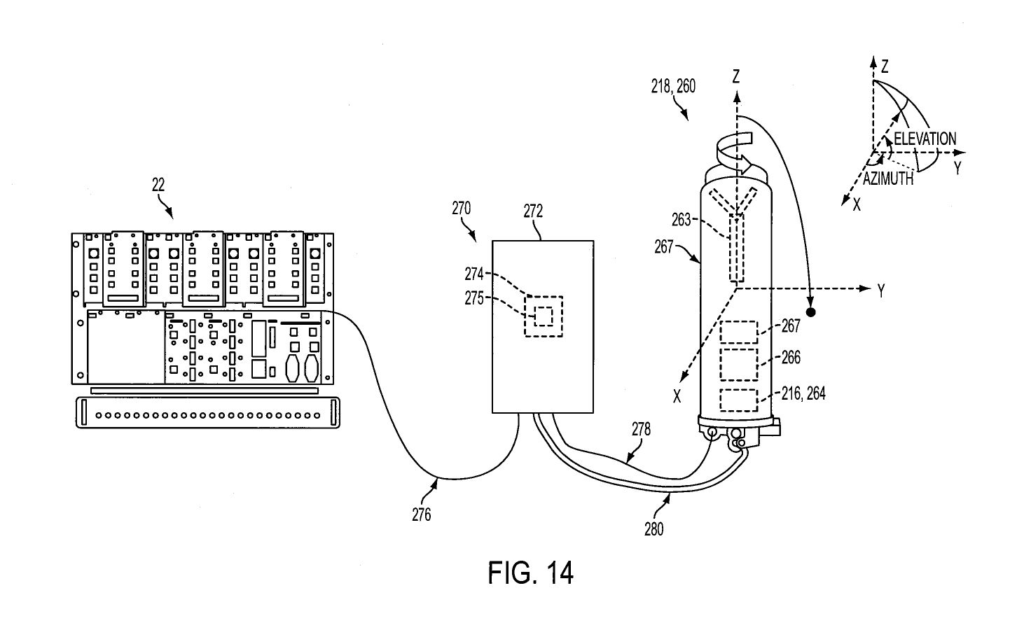

In one embodiment illustrated in FIGS. 13-14, each of the DAS remote antenna units 24 includes an antenna motor 216 as does the DAS remote antenna unit 218. In this embodiment, antenna control module 222 includes one or more interconnected circuits or circuitry 224. The circuitry 224 includes an antenna motor control circuit 226. The antenna motor control circuit 226 is configured to control the operation of the antenna motor 216. As described below, the antenna motor 216 is operable to change the radiation pattern of a DAS antenna unit 218 by physically rotating or repositioning the radiator 263 of the DAS antenna unit 218. The change in the radiation pattern results in a reduction or elimination of interference as described below.

In another embodiment illustrated in FIG. 13, the antenna control module 228 includes one or more interconnected circuits or circuitry 230. The circuitry 230 includes an antenna phase shifter 232. As described above, the antenna phase shifter 232 is operable to change the radiation patterns of the DAS antenna units 24 to tilt the patterns in different directions. The phase shifter 232 can change the phase of the antenna signal by changing the effective length of the radiator's conductive path thereby changing the signal's wavelength. Depending upon the embodiment, the antenna phase shifter 232 can change the phases of the radiation signals with or without the role of a phase control motor. In either case, the antenna phase shifter 232 is operable to change the radiation patterns of the DAS antenna units 24 without physically rotating or repositioning the radiators 263 of the DAS antenna units 24 or DAS antenna unit 218. This change in the radiation pattern results in a reduction or elimination of signal interference as described below.

In another embodiment illustrated in FIG. 13, the antenna control module 284 enables the remote radio unit 270 to change the radiation patterns of the DAS antenna units 24 and 218 without physically rotating or repositioning the radiators 263 of the DAS antenna units 24 or DAS antenna unit 218. In this embodiment, antenna control module 284 includes circuitry 286 which, in turn, includes or incorporates a radiation pattern null generator 288. In one embodiment, the null generator 288 is housed within the remote radio unit or head 270. The null generator 288 is operable to generate one or more nulls in the radiation pattern of a DAS antenna unit 24 or 218. The null generation results in a reduction or elimination of signal interference as described below.

In one embodiment, the interference reduction system 200 dynamically and automatically aligns nulls in the antenna radiation pattern with the directions of the PIM or interference sources 206. This reduces the levels or effects of the interference without impairing the signal quality of the transmission in the environment 202.

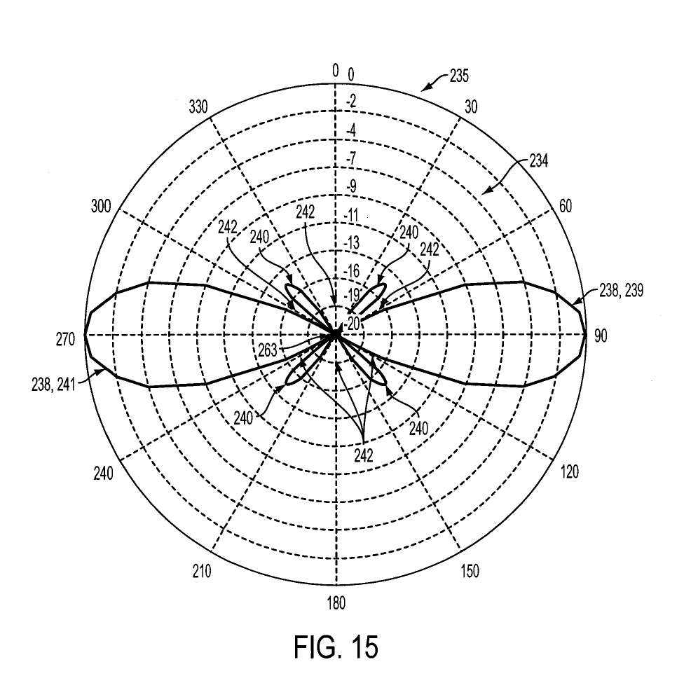

In the example illustrated in FIG. 15, each DAS remote antenna unit 24 is operable to generate electromagnetic waves which cause electromagnetic radiation. In this example, a directional antenna produces radiation that has a horizontal radiation pattern 234 as plotted on the polar plot 235. In the example shown, the dipole or radiator 263 within the directional DAS antenna unit 24 is vertically oriented with its bottom end pointing downward to the earth and its free end pointing upward to the sky. The horizontal radiation pattern 234 is expressed from a top view, looking downward at the free end of the radiator 263. In this example, the radiation pattern 234 has two main beams or main lobes 238, including right beam 239 and left beam 241. The radiation pattern 234 also has four side lobes 240. Furthermore, the radiation pattern 234 has six non-lobe areas or nulls 242 in the spaces between the lobes 238 and 240. The non-lobe areas or nulls 242 are spaces where the signal power is relatively low because the signals of the DAS antenna unit 236 fully, substantially or significantly cancel each other in such spaces.

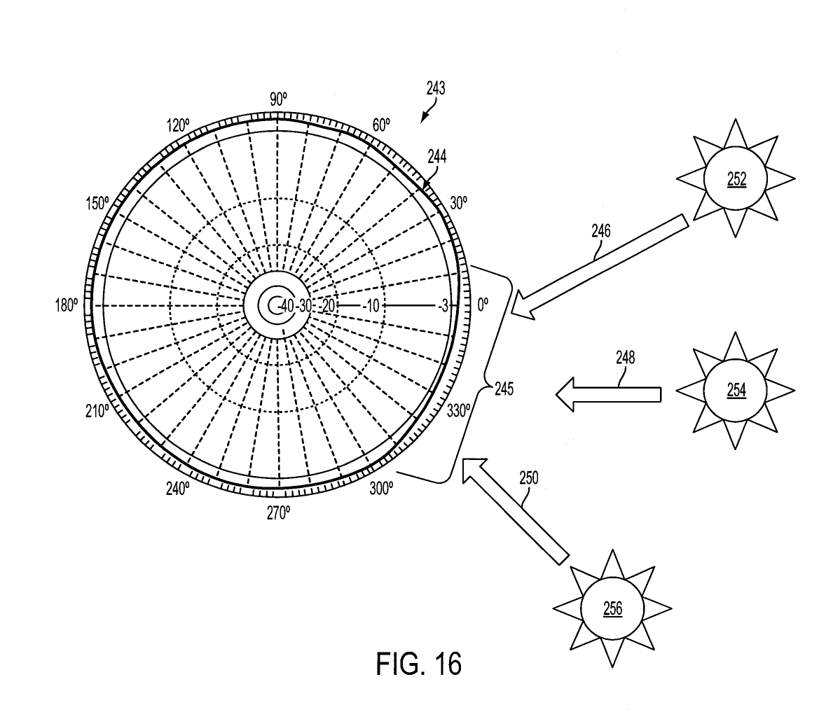

In another example illustrated in FIG. 16, the polar graph 243 for an omni-directional antenna, such as an omni-directional DAS antenna unit 24, illustrates a radiation pattern 244. The radiation pattern 244 includes an asymmetry or relatively small or slight antenna null 245 centered at approximately 330°. In contrast to nulls 242 shown in FIG. 15, in this example the slight null 245 is associated with a relatively small decrease in signal power due to a partial signal cancellation. The slight antenna null 245 is an asymmetry or asymmetrical region of the radiation pattern 244. As shown, the asymmetrical region or slight null 245 has an arc radius that is significantly greater than the radius of the otherwise circular pattern 244. In operation of this example, as described in greater detail below, the system 200 has automatically changed the location of the slight null 245 to align with the directions 246, 248 and 250 of PIM or interference sources 252, 254 and 256, respectively. This eliminates, substantially eliminates or reduces the inference caused by the interference sources 252, 254 and 256.

In one embodiment illustrated in FIGS. 11-13, a plurality of interference probes, detectors or sensors 258 are mounted in the environment 202. The interference sensors 258 are operatively coupled to the DAS manager 22. Depending upon the embodiment, the sensors 258 are coupled to the DAS manager 22 wirelessly or through wires or cables.

In operation, the interference sensors 258 enter into a detection mode when a designated event occurs, such as the satisfaction of a detection start condition. The detection start condition could be the powering-on of the sensors 258, an expiration of a designated period of time or the occurrence of a particular time based on a designated time schedule. In one embodiment, the interference sensors 258 enter the detection mode automatically, independent of, and without reliance upon, any input from a user, technician or human.

During the detection mode, the interference sensor 258 monitors the environment 202 for the presence of interference signals reflected or generated by the interference sources 206. In one embodiment, each interference sensor 258 includes an antenna, a receiver, an antenna holder, a motor and a housing. The motor, coupled to the antenna holder, causes the antenna to automatically rotate to scan the environment 202 for interference signals. The receiver receives the interference signals and produces a sensor signal or detection signal. The sensor's receiver transmits the detection signal to the DAS manager 22 together with data regarding the location, direction and characteristics of the interference signal. The DAS manager 22 controls the DAS antenna units 24 to cause the antenna units 24 to change their radiation patterns so that the nulls are aligned with the lines of direction of such interference signals. In one embodiment, the interference sensors 258 operate autonomously or semi-autonomously during a detection mode. During the detection mode, the interference sensors 258 continuously, incrementally or spectrally monitor the environment 202 for interference signals caused by changes in the environment 202.

In one embodiment, the method of operation is as follows:

(a) The interference sensors 258 are powered-on and activated.

(b) Each interference sensor 258 continuously or incrementally rotates or oscillates to spectrally monitor the environment 202 for interference signals.

(c) When an interference sensor 258 detects an undesirable signal or interference signal, the interference sensor 258 produces one or more detection signals.

(d) The DAS manager 22 receives such detection signal and applies its logic to determine which of the DAS antenna units 24 have been affected by such interference signal.

(e) The DAS manager 22 sends pattern adjustment signals to the remote radio units 270 that are associated with such DAS antenna units 24.

(f) Based on the pattern adjustment signals, such remote radio units 270 control their associated antenna motors 216 to cause the associated antennas 263 to rotate to radial positions where nulls are aligned with the direction of the detected interference signal.

(g) Steps (b) through (f) are continuously and automatically repeated in loop fashion until the interference sensors 258 are disabled for maintenance or service.

In one embodiment, the environment 202 does not include the interference sensors 258. In this embodiment, each DAS antenna unit 24 is an omni-directional antenna unit 260 as illustrated in FIG. 14. The omni-directional antenna unit 260 has: (a) antenna 263, such as a suitable conductor, conductor array, radiator, radiator set, dipole or dipole array; (b) an antenna repositioner 264; (c) a repositioning or drive mechanism 266 which couples the repositioner 264 to the antenna 263; and (d) a housing 267 which covers or encloses part or all of these components and which includes a mount for attachment to a ceiling, wall or support structure.

In one embodiment, the omni-directionality of the DAS antenna unit 260 has a relatively uniform radiation/receiving pattern in most or all directions in at least one plane. In one embodiment, the omni-directional antenna unit 260 has a 360 degree beam width, such as the radiation pattern 243 shown in FIG. 16. The antenna radiation/receiving pattern 243 of the omni-directional antenna unit 260 may include one or more nulls where the antenna pattern 243 is reduced, flattened or the cause of significant asymmetry.

Referring again to FIG. 14, in one embodiment, the repositioner 264 is a rotator which includes the repositioning motor or antenna motor 216. In such embodiment, the drive mechanism 266 includes a drive shaft and one or more drive parts or linkages, such as a gear or set of gears. The omni-directional antenna unit 260 has an antenna holder 267 having one or more guides or bearings configured to enable the rotation or spinning of the DAS antenna unit 260 about the Z-axis. In such embodiment, the radiator or conductor of the DAS antenna unit 260 is configured to extend along its longitudinal axis which, in this example is the Z-axis. The repositioner 264 is operable to rotate the antenna 263 about the Z-axis to change the azimuth angle of the antenna 263.

In one embodiment, the repositioner 264 includes a solenoid, electromagnet, electrical actuator, remote electric tilt (RET) motor, stepper motor or other suitable motor that causes the antenna 263 to: (a) fully or partially rotate about the Z-axis to change its azimuth angle; (b) vertically tilt toward the X-Y plane to change its elevation angle; or (c) both rotate and vertically tilt.

In one embodiment illustrated in FIG. 14, the DAS antenna unit 260 includes, or is operatively connected to, a remote radio head or remote radio unit 270 that controls functions of the DAS antenna unit 260. The remote radio unit 270 has: (a) a housing 272 including a mount for attachment to a wall or support structure; and (b) a controller 274 that is operatively coupled to the DAS antenna unit 260. The controller 274 has a transceiver 275. The transceiver 275 is operable to transmit signals that are radiated by the DAS antenna unit 260, and the transceiver 275 is also operable to receive signals that are directed toward, and received by, the DAS antenna unit 260.

In one embodiment, the antenna controller 274 of the remote radio unit 270 has a memory device, data storage device or circuitry configured to incorporate part or all of the antenna control module 209, 222, 228 or 284 of the system 200. In another embodiment, the DAS antenna unit 260 incorporates part or all of the components and elements of the remote radio unit 270.

In the embodiment illustrated in FIG. 14, the DAS manager 22 is connected to the remote radio head or unit 270 using a fiber optic cable 276. Depending upon the type of environment 202, the remote radio unit 270 can be mounted relatively far away from the DAS manager 22. The remote radio unit 270 transmits data to the DAS antenna unit 260 through the coaxial RF cable 278. Also, the remote radio unit 270 transmits repositioning signals or motor control signals to the antenna motor 216 through a motor control cable 280. Based on such control signals, the antenna motor 216 repositions, oscillates or rotates the antenna 263 within the housing 267. In one embodiment, the motor 216 is controlled using an Antenna Interface Standards Group (AISG) port which is incorporated into the remote radio unit 270.

In operation, the DAS antenna unit 260, under control of the remote radio unit 270, enters into a detection mode when a designated event occurs, such as the satisfaction of a detection start condition. The detection start condition could be the powering-on of the DAS antenna unit 260, an expiration of a period of time, or the occurrence of a particular time based on a designated time schedule. For example, a designated schedule could require the starting of the detection mode on a daily basis after business hours to avoid interruption of cellular service to users in the environment 202.

In one embodiment, the DAS antenna unit 260, under control of the remote radio unit 270, enters the detection mode automatically, independent of any input from a user, technician or human. During the detection mode, the repositioner 264 causes the antenna 260 to automatically reposition or rotate to scan for interference signals in the environment 202. The DAS antenna unit 260, under control of the remote radio unit 270, monitors the environment 202 for interference signals reflected or generated by interference sources 206. The DAS antenna unit 260 continuously, incrementally or spectrally monitors the environment 202 for interference signals caused by changes in the environment 202. In one embodiment, the DAS antenna unit 260 operates autonomously or semi-autonomously during the detection mode.

The DAS antenna unit 260, under control of the remote radio unit 270, receives the interference signals and produces one or more detection signals. The DAS antenna unit 260 transmits the detection signal to the remote radio unit 270 or DAS manager 22 together with data regarding the location, direction and characteristics of the interference signal. The remote radio unit 270 or DAS manager 22 rotates the antenna 260 until its nulls are aligned with the directions of such interference signals.

In one embodiment, an example of the method of operation is as follows:
(a) A detection start condition is satisfied.
(b) The DAS antenna unit 260 enters into a detection mode.
(c) The DAS antenna unit 260 continuously or incrementally rotates or oscillates to spectrally monitor for interference signals in the environment 202.
(d) When the DAS antenna unit 260 detects an undesirable signal or interference signal, the remote radio unit 270 or DAS manager 22 controls the antenna's motor 216 to cause the DAS antenna unit 260 to stop rotating at a radial position where a null is aligned with the direction of the detected interference signal.
(e) The DAS antenna unit 260 exits the detection mode.
(f) Steps (a) through (e) are automatically repeated based on a designated time schedule or the occurrence of designated events.

In one embodiment, the detection mode activity is partially or fully performed during the operation of the antennas, that is, while the DAS antennas are servicing cellular mobile phones in the environment 202.

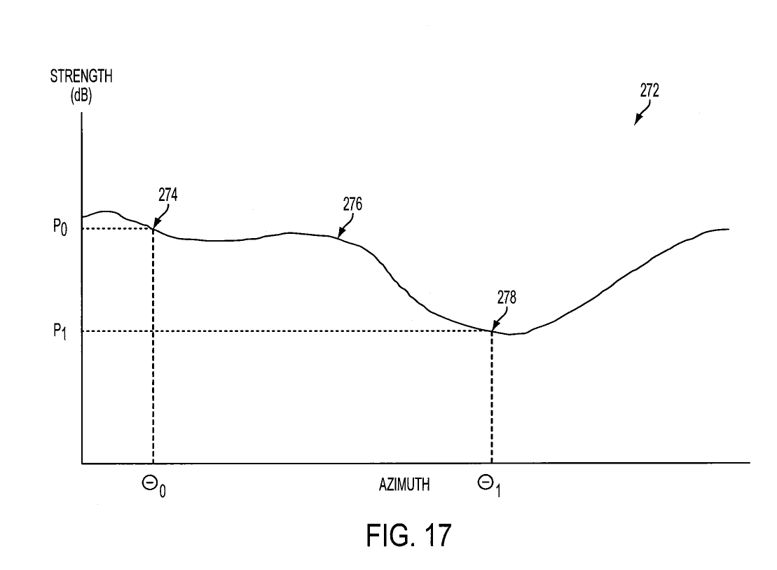

Referring to FIGS. 14 and 17, the curve 272 is an example that represents an estimation of the strength of an interference signal as a function of azimuthal orientation or azimuth angle. In this example, the interference signal is detected at an initial detection point 274, such as by using spectral monitoring to periodically or incrementally check the DAS antenna unit 260. After detecting the interference signal, the antenna motor 216 rotates the antenna 263. The spectrum monitoring module of remote radio unit 270 or DAS manager 22 performs additional spectrum analysis.

The motor 216 then rotates the antenna 263 over a range of antenna orientation angles, and the spectrum monitoring module of remote radio unit 270 or DAS manager 22 performs spectrum analysis at each step. The spectrum analysis is then used to select an orientation associated with point 276 where the strength of the interference signal is sufficiently reduced, for example, at a minimum level. The DAS manager 22 then proceeds to operate the DAS antenna unit 260 at the selected orientation 278.

In another embodiment, the rotation of the antenna 263 may be stopped when the spectrum analysis indicates that the strength of the interference signal is below a designated value or threshold value. This process may be applied where there are multiple interference sources 206. For example, the selection of orientation 278 may be based on an average strength of the interference signals or a weighted analysis of the strengths of the interference signals.

In another embodiment of any one of the embodiments described above, the rotation of the antenna 263 may be based on an algorithm or a set of algorithms. The rotation may be performed in stages, for example, using a large increment for a large range of angles in one stage and then using smaller increments in a smaller sub-range of angles in another stage. Additionally, the increment may be based on the size of a null.

Referring back to FIG. 13, it should understood that the antenna control modules 228 and 284 are operable to reduce interference for a DAS antenna unit 24 even when such unit 24 does not have a motor or antenna repositioner. For example, the antenna control module 228 enables the remote radio unit or head 270 to achieve null alignment with the interference signals without physically rotating or repositioning the antenna of the DAS antenna unit 24. In one embodiment, the antenna phase shifter 232 is housed within the remote radio unit 270. The phase shifter 232 is operable to shift the phases of the signal waves produced by a plurality of radiator elements in the antenna unit 24. This phase shifting for the antenna unit 24 causes its radiation pattern to change so as to align the its nulls with the directions of the interference signals. With respect to antenna control module 284, the null generator 288 is operable to produce nulls in the radiation pattern of an antenna unit 24. The nulls are produced at selected radial locations that align with the directions of the interference signals.

In one embodiment, the DAS manager 22 communicates with, and receives an RF feed from, the base station 204. In another embodiment, the base station 204 transmits key performance indicators (“KPI”) data to the DAS manager 22. The KPI data relates to characteristics of the cellular traffic, network performance and antenna signals, such as information related to the volume of dropped calls. The DAS manager 22 receives the KPI data feed from the base station 204 through a common public radio interface (“CPRI”). In this embodiment, the DAS manager 22 performs the null alignment steps described above based, at least in part, on this KPI data. Depending upon the embodiment: (a) the DAS manager 22 could cause the DAS antenna units 24 to rotate based on the KIP data, (b) the DAS manager 22 could cause the DAS antenna units 24 to generate nulls based on the KIP data, or (c) the DAS manager 22 could cause the DAS antenna units 24 to reposition nulls based on the KIP data.

By repositioning a DAS antenna or otherwise altering the radiation pattern, the system 200 reduces or minimizes interference encountered by the DAS antenna. This enables the system to dynamically orient nulls in the antenna pattern based on interference power level detected. The null alignment, null steering, null manipulation or null production process of the system 200 provides significant performance gains in the antenna network resulting from the decrease in interference. In this way, the system 200 performs an automated, dynamic reduction or minimization of the effects of the antenna interference.

### 3. Remote Control of DAS Antennas

In one embodiment, a remote control device enables a technician to control the movement of the antenna of a DAS antenna unit 218 mounted in an environment 202, such as a building. In such embodiment, the DAS manager 22 or remote radio unit or head 270 includes a remote control module. The remote control logic of such module enables the remote control device to communicate with the DAS manager 22 or radio unit 270. In one embodiment, the remote control device is a handheld remote control operable to send and receive RF, infrared or other signals wirelessly. In another embodiment, the remote control device is a cell phone, computer notebook, computer laptop or Internet access device. Using the remote control device, a technician can control the movement of the antenna or radiator within the DAS antenna unit 218 to eliminate or reduce interference from interference sources 206. For example, instead of having to climb a ladder to reach a DAS antenna unit 218, the technician can remain on the floor and enter position adjustments inputs by pressing buttons or typing on a keyboard of a computer or other remote control device. The technician's inputs adjust the orientation of the antenna or radiator within the DAS antenna unit 218 even though it may be fifty feet or more above floor level. After adjustment, the technician checks the antenna unit's interference and performance. Based on that check, the technician can make further adjustment inputs until achieving the desired performance. In this embodiment, the technician may perform the null alignment procedures described above or any other suitable adjustment techniques.

### 4. Antenna Beam Manipulator

In one embodiment, an antenna beam manipulator is operable to steer, produce or form one or more beams of a directional antenna of a DAS antenna unit 24. The antenna beam manipulator, in one embodiment, includes logic storable by the data storage device 212 of the DAS manager 22 in the form of computer code, software, beam steering algorithms, beam forming algorithms, data libraries, a plurality of machine-readable instructions or a combination thereof. Such logic is executable by an integrated circuit or data processor of the DAS manager 22. In another embodiment, the antenna beam manipulator has a hardware form, including beam steering circuitry or beam forming circuitry. In such embodiment, the hardware can include one or more electrical switches, dielectric components, resisters, capacitors, inductors and transformers.

Referring to FIGS. 14-15, the antenna beam manipulator enables the DAS manager 22 to automatically steer the beams 238 of a directional antenna unit 218 toward desired targets or otherwise form beams 238 so that they are directed toward desired targets. The targets can be located in or near the environment 202 which may be, for example, a stadium, an outdoor concert or an outdoor amusement park.

In one embodiment, a plurality of motion detectors, infrared heat sensors, sensors, video recorders, satellites or other crowd monitors could be mounted or operated to detect relatively high concentrations of attendees, including people using cellular phones. The crowd monitors are operatively coupled to the DAS manager 22. The crowd monitors continuously or periodically send crowd detection signals to the DAS manager 22. Each crowd detection signal is associated with: (a) a designated level of crowd concentration or density; and (b) geographical data or directional data related to the location of the crowd, such as spatial coordinates. Based on a crowd detection signal, the DAS manager 22 automatically steers one or more beams 238 of a directional antenna unit 218 toward the location of the crowd or otherwise forms one or more beams 238 so that they are directed toward the crowd. As a result, the beams 238 can reach the targeted crowd with higher strength and enhanced performance.

Accordingly, the antenna beam manipulator, in cooperation with the target monitors, enables the DAS manager 22 to automatically and dynamically adjust the orientation and performance of the antenna units 218, in feedback loop fashion, based on changes in designated targets in or near the environment 202.

With continued reference to FIGS. 14-15, in one embodiment, the environment 202 receives RF feeds through coaxial cables from a plurality of base stations 204, such as base station A and base station B. The DAS manager 22, under control of the antenna beam manipulator, is operable to produce or steer antenna beams 238 so that beam 239 is aimed at crowd population A, and beam 141 is aimed at crowd population B. The DAS manager 22 uses base station A's RF feed to operate beam 239, and the DAS manager 22 uses base station B's RF feed to operate beam 241. In this way, each crowd population can receive a relatively high level of signal power from a non-shared base station.

In another embodiment, the DAS manager 22 is operable according to the antenna beam manipulator without reliance upon target sensors or monitors. The following is an example method of operation of such embodiment:
(a) The DAS manager 22 activates and powers-on a plurality of directional antenna units 218.
(b) Under control of the DAS manager 22, each directional antenna unit 218 enters into search mode when a designated search mode start condition is satisfied.
(c) During search mode, each directional antenna unit 218 continuously rotates three hundred sixty degrees or oscillates back and forth between an angle less than three hundred sixty degrees.
(d) During the rotation or oscillation, the directional antenna unit 218 transmits search result signals to the DAS manager 22.
(e) The DAS manager 22 applies its logic to determine when the search result signals correspond to, and indicate, the locations of targets, such as dense crowd populations.
(f) The DAS manager 22 controls each directional antenna unit 218 to stop its rotation or oscillation at a position so that its beam 238 is aimed toward one of the targets.
(g) Under control of the DAS manager 22, each directional antenna unit 218 ends the search mode and then sends and receives signals for cellular service.
(h) When the search mode start condition occurs again, steps (b) through (g) are automatically repeated as part of a feedback loop.

In one embodiment, the beam manipulator incorporates a beam steering module or beam steerer. The beam steerer is operable to change the aim of a beam by electrically switching the antenna radiators or by changing the relative phases of the RF signals that drive the antenna radiators. In another embodiment, the beam manipulator incorporates a beam former. The beam former is operable to change the directionality of an array of radiators by controlling the phase and relative amplitude of the radiated signal of each radiator. The resulting radiation pattern is based on constructive and destructive interference in the wavefront. The signals received from the different radiators can be amplified by different “weights.” Different weighting patterns can be used to achieve desired sensitivity patterns. Depending upon the embodiment, the beam former can be a fixed or switched-type beam former, a phased array beam former or an adaptive beam former.

In one embodiment, the antenna beam manipulator is operable without reliance upon the interference reduction system 200 and without the involvement of null detection. In another embodiment, the antenna beam manipulator is fully or partially incorporated into the interference reduction system 200.

Additional embodiments include any one of the embodiments described above, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

The following is claimed:

1. An interference reduction system for at least one antenna, the interference reduction system comprising:
at least one antenna control module configured to be operatively coupled to the at least one antenna, the at least one antenna being operable to produce radiation having a radiation pattern, the radiation pattern having at least one null, the at least one antenna control module configured to:
start a detection mode when a detection start condition is satisfied independent of any input from a user;
control an antenna motor that is operatively coupled to the at least one antenna so as to cause the at least one antenna to rotate during the detection mode;
detect at least one source of interference within a detectable range of the at least one antenna, wherein the at least one antenna receives at least one interference signal caused by the at least one source of interference; and
control the at least one antenna motor to stop the rotation of the at least one antenna so as to align the at least one null with a direction of the received interference signal.

2. The interference reduction system of claim 1, wherein the at least one antenna control module is at least partially incorporated into a distributed antenna manager that manages the at least one antenna and a plurality of other antennas.

3. The interference reduction system of claim 1, wherein the at least one antenna control module is at least partially incorporated into a remote radio unit that is operatively coupled to the at least one antenna.

4. The interference reduction system of claim 1, wherein the at least one antenna control module comprises a data storage device.

5. The interference reduction system of claim 4, wherein the data storage device stores a plurality of machine-readable instructions that are executable by a processor.

6. The interference reduction system of claim 1, wherein the at least one antenna control module comprises at least one circuit.

7. The interference reduction system of claim 1, wherein the detection start condition comprises one of: (a) a detection time schedule; (b) an expiration of a period of time; and (c) a sensor signal generated by a sensor, wherein the sensor is operatively coupled to the at least one antenna control module.

8. The interference reduction system of claim 1, wherein the radiation pattern has a plurality of lobes and first and second nulls and wherein the at least one antenna control module is configured to:
detect a first interference signal that traveled in a first direction toward the at least one antenna and was received by the at least one antenna during the detection mode;
detect a second interference signal that traveled in a second direction toward the at least one antenna and was received by the at least one antenna during the detection mode; and
control the at least one antenna motor to stop the rotation of the at least one antenna so as to:
reposition the first null to be closer to the first direction of the first interference signal; and
reposition the second null to be closer to the second direction of the second interference signal.

9. An interference reduction system for at least one antenna, the interference reduction system comprising:
at least one antenna control module configured to be operatively coupled to the at least one antenna, the at least one antenna being operable to produce radiation having a radiation pattern, the radiation pattern having at least one null, the at least one antenna control module configured to cause the at least one null to be aligned with an interference signal traveling toward the at least one antenna.

10. The interference reduction system of claim 9, wherein the at least one antenna control module is configured to receive a sensor input from a sensor that is operatively coupled to the at least one antenna control module, the at least one antenna control module being configured to cause the at least one null to be aligned with the interference signal in response to the sensor signal.

11. The interference reduction system of claim 9, wherein the at least one antenna control module is configured to produce at least one detection signal associated with the interference signal, the at least one antenna control module being configured to cause the at least one null to be aligned with the interference signal in response to the at least one detection signal.

12. The interference reduction system of claim 9, wherein the at least one antenna control module is at least partially incorporated into a distributed antenna manager that manages the at least one antenna and a plurality of other antennas.

13. The interference reduction system of claim 9, wherein the at least one antenna control module is at least partially incorporated into a remote radio unit that is operatively coupled to the at least one antenna.

14. The interference reduction system of claim 9, wherein the at least one antenna control module comprises a plurality of machine-readable instructions that are executable by a processor.

15. The interference reduction system of claim 9, wherein the at least one antenna control module comprises at least one circuit.

16. The interference reduction system of claim 9, wherein the at least one antenna control module comprises a motor control module configured to control an antenna motor that is operatively coupled to the at least one antenna.

17. The interference reduction system of claim 9, wherein the at least one antenna control module comprises a phase shift module configured to change the radiation pattern without physically moving the at least one antenna.

18. An interference reduction system for at least one antenna, the interference reduction system comprising:
at least one antennal control module configured to be operatively coupled to the at least one antenna, the at least one antenna being operable to produce radiation including a plurality of antenna signals, the radiation having a radiation pattern, the radiation pattern having at least one lobe and at least one non-lobe area where a plurality of the antenna signals at least partially cancel each other, the at least one antenna control module configured to:
monitor at least one antenna for at least one undesirable signal traveling in a direction toward the at least one antenna, wherein the at least one undesirable signal causes a level of interference with at least one of the antenna signals;
produce at least one detection signal after the at least one undesirable signal is detected; and
in response to the at least one detection signal, align the at least one non-lobe area with the direction of the detected undesirable signal to reduce the level of interference.

19. The interference reduction system of claim 18, wherein the at least one antennal control module is operatively coupled to an antenna motor that is operatively coupled to an antenna mover, the at least one antenna mover being configured to move the at least one antenna, the at least one antennal control module configured to cause the at least one antenna mover to incrementally move the at least one antenna during the monitoring.

20. The interference reduction system of claim 19, wherein the at least one antennal control module is configured to cause the at least one antenna mover to move the at least one antenna until the at least one non-lobe area is aligned with the direction of the detected undesirable signal.
